(19) United States
(12) Patent Application Publication
(10) Pub. No.: US 2006/0091807 A1
(43) Pub. Date: May 4, 2006

(54) Flat lamp, production method thereof and application of same

(76) Inventors: Thomas Bertin-Mourot, PARIS (FR); Alain Neuillet, Noyon (FR); Yannick Lebail, Chevincourt (FR); Jingwei Zhang, Massy (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/523,393

(22) PCT Filed: Jul. 30, 2003
(86) PCT No.: PCT/FR03/02415

§ 371 Date: Aug. 23, 2005

(30) Foreign Application Priority Data
Aug. 6, 2002 (FR) 02/10020

(51) Int. Cl. H01J 65/00; H01J 1/62

(52) U.S. Cl. 313/607; 313/493

(57) ABSTRACT

A flat lamp including at least two glass substrates kept mutually parallel and defined in an internal gas-filled space, including two electrodes associated with the glass substrates and away from the internal space, in which the internal face of at least one substrate turned toward the internal space is coated with a phosphor material. At least one of the electrodes is covered with at least one preferably transparent electrical insulation that may be formed by at least one of the glass substrates or be associated with at least one of the glass substrates.

The invention relates to the field of luminaires and more particularly to a flat discharge lamp that can be used as a decorative or architectural luminaire.

Flat lamps, such as those used for the manufacture of backlit screen devices, may be formed from two glass sheets held slightly apart, generally by less than a few millimeters, and hermetically sealed so as to contain a gas at reduced pressure, in which an electrical discharge produces radiation generally in the ultraviolet range that excites a phosphor substance, that then emits visible light.

In a standard structure, a glass sheet has, on one and the same face, two screen-printed coatings, especially made of silver, in the form of interpenetrating combs that constitute a cathode and an anode. This face is turned toward the space containing the plasma gas. Another glass sheet is kept at a certain distance from the first one by means of discrete spacers and optionally by a peripheral frame. Generated between the anode and the cathode is what is called a coplanar discharge, that is to say one in a direction hugging the main surface of the glass substrate, which discharge excites the surrounding plasma gas. The electrodes are protected by a dielectric coating designed to avoid, by capacitive limitation a loss of material of the electrodes by ion bombardment in the vicinity of the glass substrate. At least one of the glass substrate faces turned toward the space containing the gas furthermore carries a coating of phosphor material.

This coplanar discharge lamp structure, whose function is to provide maximum light power with a very thin device, proves to be very complex. Its high cost means that it is intended only for high added-value applications.

The object of the present invention is to propose a flat illuminating element capable of offering novel possibilities in terms of decoration, display and/or architecture.

In this regard, the subject of the invention is a flat lamp comprising at least two glass substrates kept mutually parallel and defined in an internal gas-filled space, comprising two electrodes associated respectively with the two glass substrates and away from the internal space, in which the internal face of at least one substrate turned toward said internal space is coated with a phosphor material, characterized in that at least one of the electrodes is covered with at least one preferably transparent electrical insulation that may be formed by at least one of the glass substrates or be associated with at least one of the glass substrates.

The electrical, preferably transparent, insulation thus allows the electrodes to be electrically isolated from the outside for safety of the public.

According to one embodiment, at least one electrode is affixed to the surface of the external face of the substrate with which it is associated and is covered with at least one electrical insulation, the electrode being incorporated into the surface of the glass substrate or of the electrical insulation.

According to another embodiment, at least one electrode is incorporated into the electrical insulating material, either within its very thickness or on the surface.

According to these embodiments, this electrical insulation is made of glass or of a transparent plastic such as polyvinyl butyral (PVB), ethylene/vinyl acetate (EVA) or polyethylene terephthalate (PET).

According to yet another embodiment, the electrical insulation is formed by the glass substrate as such, the electrode being incorporated into its thickness.

One or more other additional, preferably transparent, electrical insulations, made of glass or of any other material such as a plastic (PVB, PET EVA) that may also have other functionalities, for example for providing an optical effect, especially a colored effect, a decorative effect, produced by screen printing or otherwise, with a structured relief, a delustered effect, or with a scattering layer, etc., may be joined to this electrical insulation as formed, depending on the various embodiments.

Thus, joining one or more electrical insulations to the glass substrate(s) of the lamp makes it possible, apart from protecting the electrodes, to produce decorative or illuminating objects incorporating decorative plates that present flat decorations, for example photographs, screen printing, enameled decorations, etc.

In particular, an additional electrical insulation is also formed by another glass substrate that is laminated to at least one of the glass substrates constituting the lamp via an intermediate plastic film or other material, especially a resin, that can make the two substrates adhere to each other.

According to another feature, the second electrode is joined in the same way as the first electrode or according to an alternative embodiment given above.

This structure, by placing the electrodes on the outside of the enclosure containing the plasma gas at reduced pressure, allows the manufacturing cost of the lamp to be considerably lowered, with illumination characteristics well suited to the use as a luminaire.

In this configuration, the glass substrate acts as capacitive protection for the electrodes against ion bombardment.

Furthermore, the problem of connection to the power supply is solved much more simply than in the case of the known systems in which the electrical connectors must pass through the hermetically sealed enclosure containing the gas.

The term “translucent element” is understood to mean an element whose constituent material is translucent or transparent, but also elements made of a material that can absorb a substantial fraction of the light radiation but is distributed with respect to the surface of the substrate in a pattern such that all the light radiation emitted by the lamp is altered very little by the element. Such generally translucent elements may be formed by a grid, an array of wires, an etched or screen-printed coating, etc.

Preferably, an electrode that can be used in the invention is in the form of a transparent or translucent conductive coating deposited directly on the substrate by standard thin-film deposition, by etching or by screen printing. In particular, the electrode is a continuous conductive coating, that is to say one that entirely covers large areas of the surface of the substrate.

Advantageously, the two electrodes are continuous conductive coatings each located on the external face side of a substrate and at least partly covering the facing surfaces of said substrates. Preferably, the two electrodes are transparent coatings.

The continuous and the uniform coatings forming the electrodes may be manufactured on large substrates by methods of very high productivity.

The continuous coatings may cover all or part of the external faces facing the glass substrates. It is possible to provide only certain areas of the external surface of one or the substrates so as to create predefined illumination regions on one and the same surface. These regions may optionally constitute decorative patterns or constitute a display, such as a logo or a mark.

For example, the continuous coatings may be in the form of an array of parallel bands, having a bandwidth of between 3 and 15 mm, and a non-conducting space between two adjacent bands, having a width greater than the width of the bands. These coatings deposited on the two substrates being offset by 180° so as to prevent two opposed conducting bands of the two substrates from facing each other. Advantageously, this makes it possible to reduce the effective capacitance of the glass substrates, favoring the supply of the lamp and its efficiency in terms of lumens/W.

The electrodes may be made of any conducting material that can be made in the form of a flat element allowing light to pass through it, in particular that can be deposited as a thin layer on glass or on a plastic film, such as a PET film, as a coating that lets light through it. According to the invention, it is preferred to form a coating from a conducting metal oxide or an oxide having electron vacancies, such as fluorine-doped tin oxide or mixed indium tin oxide.

The electrodes may instead be in the form of a metal grid incorporated into a film of plastic such as polyvinyl butyral (PVB), ethylene/vinyl acetate (EVA) or other plastic, where appropriate inserted between two plastic sheets.

Likewise, all or part of the internal faces of at least one of the two substrates may be coated with a phosphor material. Thus, even if continuous electrodes covering all of the surface of the glass substrates cause discharges throughout the volume of the lamp, a differentiated distribution of the phosphor in certain regions makes it possible to convert the energy of the plasma into visible radiation only in the regions in question, so as to constitute illuminating regions and juxtaposed transparent regions.

The phosphor material may advantageously be selected or adapted so as to determine the color of the illumination within a broad pallet of colors.

According to one embodiment, spaced between the two glass substrates are spacers made of a nonconducting material, said spacers keeping the two substrates apart. These spacers, that may be termed discrete spacers when their dimensions are considerably smaller than the dimensions of the glass substrates, may be of various shapes, for example spheres, bitruncated spheres with parallel faces or cylinders, but also parallelepipeds of polygonal cross section, especially in the form of a cross, as described in document WO 99/56302.

The spacing between the two substrates may be set by the spacers to a value of around 0.3 to 5 mm, especially less than or equal to about 2 mm. One technique of depositing the spacers in vacuum insulating glazing assemblies is known from FR-A-2 787 133. According to this process, spots of adhesive are deposited on a glass sheet, especially spots of enamel deposited by screen printing, with a diameter less than or equal to the diameter of the spacers, and the spacers are rolled over the said glass sheet, which is preferably inclined, so that a single spacer adheres to each spot of adhesive. The second glass sheet is then applied to the spacers and a peripheral seal is deposited.

The spacers are made of a nonconducting material so as not to participate in the discharges or to cause a short circuit. Preferably, they are made of glass, especially of the soda-lime type.

To prevent loss of light by absorption in the material of the spacers, it is possible to coat the surface of the latter with a phosphor material identical to or different from that used for the glass substrate(s).

In the structure of the flat lamp according to the invention, the gas pressure in the internal space may be around 0.05 to 1 bar, advantageously around 0.05 to 0.6 bar. The gas used is an ionizable gas that can form a plasma (a “plasma gas”), especially xenon or neon, by themselves or as a mixture.

According to one embodiment, the lamp may be produced by firstly manufacturing a sealed enclosure in which the intermediate air cavity is at atmospheric pressure, and then by creating a vacuum and introducing the plasma gas at the desired pressure. According to this embodiment, one of the glass substrates includes at least one hole drilled through its thickness and obstructed by a sealing means.

The subject of the invention is also a process for manufacturing a lamp as claimed in any one of the preceding claims, comprising the steps in which:

optionally, at least one electrode is deposited on one of the glass substrates;

the phosphor is screen-printed on at least one of the glass substrates, one of which is provided with a hole drilled through its thickness and on the opposite side from the electrode if the latter is deposited on the same substrate;

spacers are deposited on one of the glass substrates;

the glass substrates are joined together so as to be parallel;

the internal space is sealed by means of a peripheral sealing material;

the atmosphere contained in the internal space is replaced, via the hole, with the plasma gas; and

the hole is obstructed by a sealing means;

optionally, at least one first electrical insulation is joined to at least one glass substrate, the electrical insulation being intended to cover or to incorporate, internally or on the surface, the electrode with which one of the faces of said substrate has to be associated, or intended to cover the electrode that is associated with a second electrical insulation that is joined to the first electrical insulation.

To replace the atmosphere with the gas, it is possible to use a method that involves pumping through a double- or multiple-glazing structure, such as the method described for example in document EP-A-645 516. The latter proposes, as sealing material, a suspension of solder glass frit. This material is placed in the form of a bead at the external end of the hole right at the start of manufacture, a vacuum is created through this component and is then softened so as to obstruct the hole.

Another process is described in FR-A-2 774 373 that proposes, as sealing material, a low-melting-point alloy. This material may be placed in the form of a component having a shape matched to the external end of the hole right at the start of manufacture, a vacuum is created through this component and then it is melted in order to seal it to the wall of the hole so as to obstruct the latter.

A preferred process according to the invention consists in obstructing the hole with a sealing pad that covers the external orifice of the hole. This pad, advantageously made of metal, may be bonded to the glass substrate by welding.

The flat lamp according to the invention may be used as a luminaire for illumination and/or decoration purposes. The dimensions of the luminaire may be of the order of those current enclosures with so-called “neon” tubes, or much larger, for example at least 1 m². Using the flat lamp offers better visual comfort than these tubes, by emitting more diffuse light, and ensures a much longer lifetime.

The glass substrates may be of any shape: the outline of the substrates may be polygonal, concave or convex, especially square or rectangular, or curved, with a constant or variable radius of curvature, especially round or oval.

The flat lamp according to the invention may advantageously be used as a luminaire capable of illuminating simultaneously by both its main faces. This is because its structure includes no opaque or reflecting layer capable of limiting the transmission of light on one side or the other of the lamp. However, for esthetic reasons, it is possible to prevent illumination through one face or part of one face of the lamp, for example in order to contribute to the formation of the desired pattern. Similarly, the lamp itself may be provided with such a screen, or else this screen may be joined to it when mounting the final luminaire.

With reference to the foregoing description, the invention also relates to the application of a lamp as described to the production of architectural or decorative elements that illuminate and/or have a display function, such as flat luminaires, illuminating walls, especially suspended walls, illuminating tiles, etc.

Other details and features of the invention will become apparent from the detailed description that follows, with regard to the appended drawings in which:

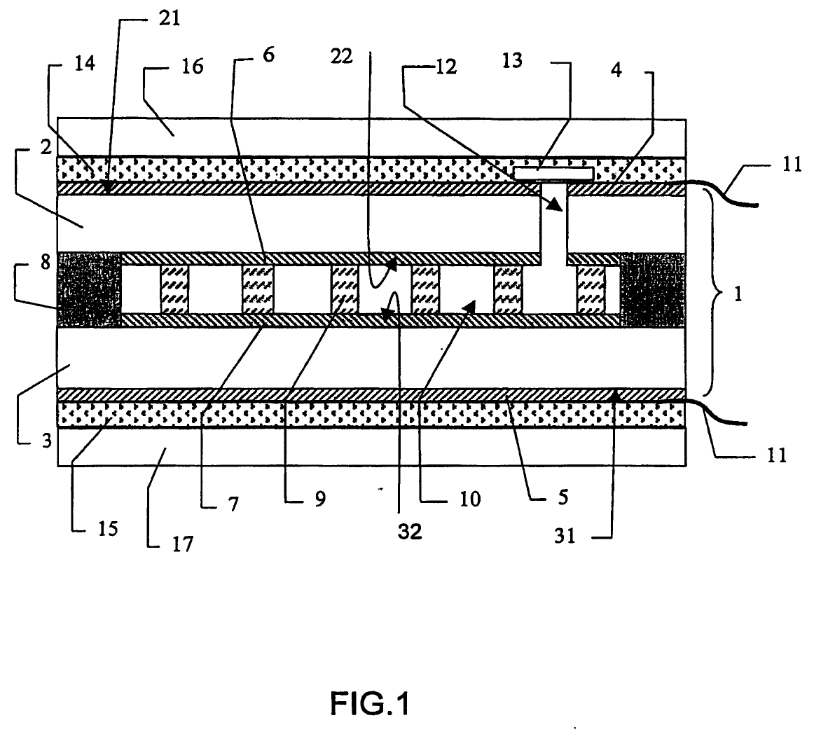

FIG. 1 shows a schematic sectional view of a flat lamp according to the invention; and

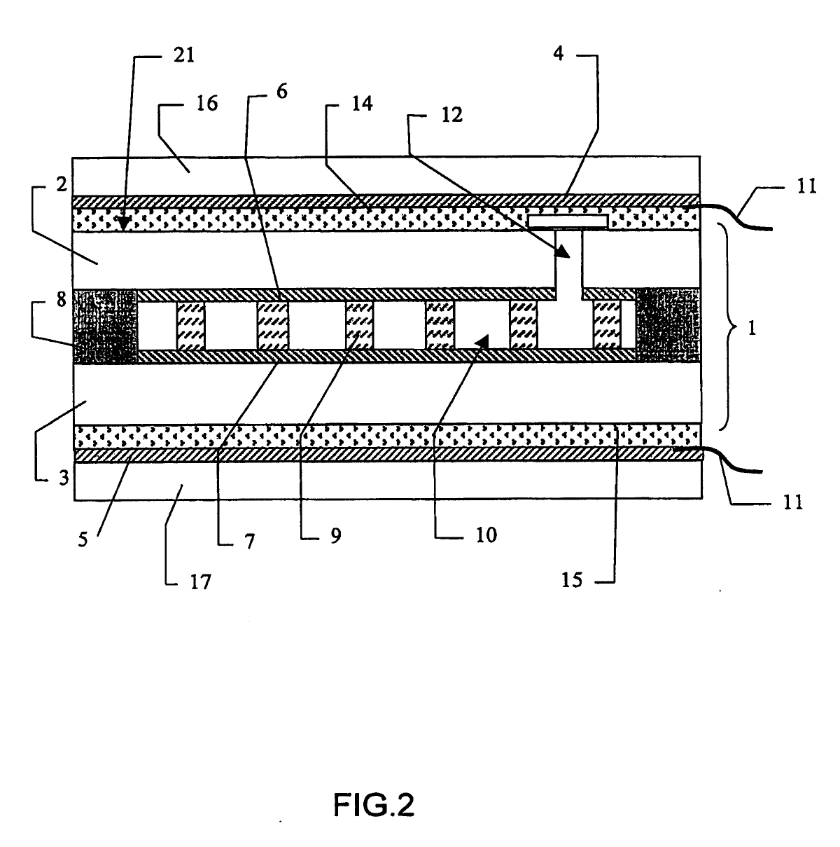

FIGS. 2, 3 and 4 show schematic sectional views of other embodiments of a flat lamp according to the invention.

It should be pointed out that for the sake of clarity the various elements of the objects shown have not necessarily been drawn to scale.

FIG. 1 shows a flat lamp 1 consisting of two substrates made of glass sheets 2, 3 having a first face 21, 31, with which a continuous and uniform conductive coating 4, 5 constituting an electrode is associated, and a second face 23, 32 that carries a coating of a phosphor material 6, 7.

The conductive coating may be joined to the substrate in various ways: it may be deposited directly on the face 21, 31 of the substrate or else deposited on an electrical insulation carrier element 14, 15, this carrier element being joined to the substrate in such a way that the coating is pressed against the face 21, 31 of the substrate. The electrical insulation 14, 15 may, for example, be a plastic film of the EVA or PVB type.

Optionally, an additional insulation 16, 17 may be added to the insulating element 14, 15 of the electrode.

The sheets 2, 3 are put together with their second faces 22, 32 carrying the phosphor 6, 7 facing each other and are joined together by means of a sealing fit 8, the gap between the glass sheets being set (at a value generally less than 5 mm) by glass spacers 9 placed between the sheets. Here, the gap is around 0.3 to 5 mm, for example 0.4 to 1 mm.

The spacers 9 may have a spherical, cylindrical or cubic shape, or a shape of any other polygonal, for example cruciform, cross section. As examples, mention may be made of the TAGLIA® cruciform spacers sold by Display Glass. The spacers may be coated, at least on their lateral surface exposed to the plasma gas atmosphere, with a phosphor identical to or different from the phosphor 6, 7 chosen from standard phosphors.

In the space 10 between the glass sheets is a rare gas, such as xenon, optionally mixed with neon, at a reduced pressure, generally around one tenth of an atmosphere. The conducting layers 4, 5 based on the outside of the assembly, forming the electrodes, are connected to an appropriate power supply (not shown) via flexible leads 11.

A glass sheet 2 has, near the periphery, a hole 12 drilled through its thickness, the external orifice of which is obstructed by a sealing pad 13, especially made of copper bonded to the external face of the sheet bearing the electrode 4.

The lamp is manufactured in the following manner: the substrates, cut and made to the desired shape, are produced from a glass sheet, for example about 3 mm in thickness, coated with a thin layer of fluorine-doped SnO₂. A through-hole 12 a few millimeters in diameter is made near the edge of the substrate 2.

The functional phosphor layers 6, 7, and possibly other functional, for example power supply, elements, are deposited, especially by screen printing.

The spacers 9 are deposited on the layer 7 of the substrate 3 at predefined positions, for example by means of an automaton, and the substrate 2 is applied with its internal face 22 facing the internal face 32 of the substrate 3. A sealing fritt is deposited around the internal peripheral band of the two substrates and a high-temperature sealing operation carried out.

Next, by means of a pump, the atmosphere contained in the sealed enclosure is removed through the hole 12 and is replaced with the xenon/neon mixture. When the desired gas pressure is reached, the sealing pad 13 is placed over the opening of the hole 12, around which a bead of welding alloy has been deposited. A heat source is activated near the weld so as to cause the latter to soften, and the pad 13 is pressed by gravity against the orifice of the hole and thus welded to the substrate 2, forming a hermetic plug.

This structure makes it possible to manufacture a lamp with standard glass products, glass coated with fluorine-doped SnO₂ (electrodes) being widely used in glazing assemblies. Then, the addition of the electrical insulation 14, 15 being carried out in a known manner depending on the type of material, by casting a cold resin or by hot bonding of a thermoplastic sheet.

In the embodiment shown in FIG. 2, the structure of the lamp basically repeats the structure of FIG. 1, apart from the arrangement of a conductive coating or electrode 4, 5.

The conductive coating 4, 5 is sandwiched between a first electrical insulation 14, 15 and a second electrical insulation, or additional insulation, 16, 17, the combination being joined to the glass sheet 2, 3.

These electrical insulations 14, 15, 16, 17 may be formed as various combinations that combine, for example, a glass sheet and/or plastic films, of the PVB or PET type, or other resins capable of being adhesively joined to glass products.

Thus, the glass sheet 2, 3 may support, as combination, a PBV sheet 14, 15 bonded to the glass sheet as first electrical insulation and, as second electrical insulation 16, 17, a glass or a plastic film joined to the PVB sheet, the electrode being placed between the two electrical insulations.

Another combination of electrical insulations (not illustrated) is as follows: a PVB sheet is taken as first electrical insulation, that will serve to bond the second electrical insulation and carrier of the electrode, such as a PVB sheet, the electrode being between the PVB sheet and the PET sheet, and a third electrical insulation, such as a PVB sheet, that will cover the PET sheet in order to protect it from being scratched.

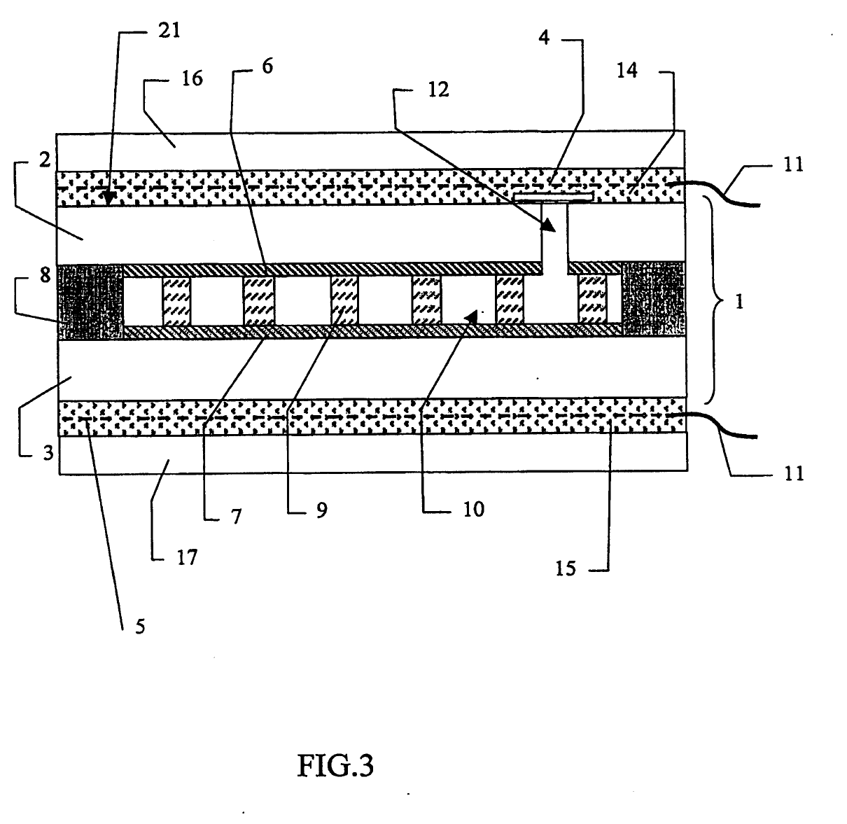

The embodiment shown in FIG. 3 repeats that of FIG. 2, except that the electrode is not incorporated at a face of an electrical insulation but is incorporated into the thickness of the first electrical insulation 14, 15.

The manufacture of the lamp according to FIGS. 2 and 3 takes place as explained above, without the step of depositing the conductive coatings. A step of laminating the electrical insulations provided with conductive coatings, on the external faces 21, 31 of the lamp, is carried out after the step of obstructing the hole in the structure.

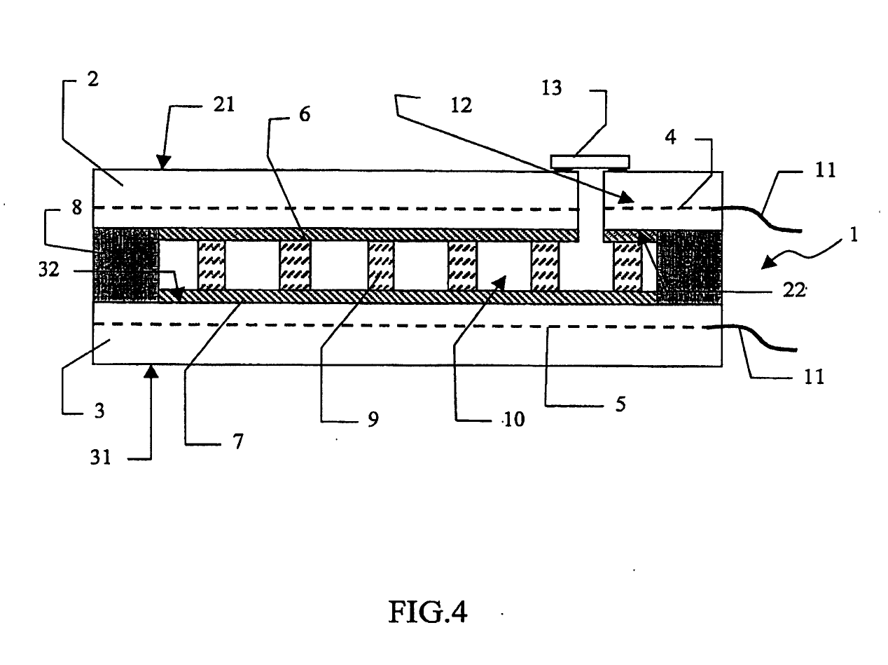

In the embodiment shown in FIG. 4, the structure of the lamp also basically repeats the structure of FIG. 1, except for the arrangement of the conductive coating or electrode 4, 5.

Here, the conductive coating 4, 5 is incorporated into the glass sheet 2, 3 that constitutes the electrical insulation as such.

Additional electrical insulations, not shown here, may be laminated with at least one glass sheet.

The manufacture of the lamp takes place as explained in the case of FIG. 1 without the step of depositing the conductive coatings, since they have already been incorporated into the glass sheets.

The examples that have just been described in no way limit the invention.

In particular, in the embodiments that have just been described the electrodes were formed from coatings covering the entire surface of the glass sheets, but it is understood that at least one of the glass sheets may have a group of electrodes formed from several regions, each having a surface of greater or lesser area each covered with a continuous coating.

Moreover, in the embodiments described above, the alternative ways of assembling the conductive elements may be applied differently to each of the glass sheets 2, 3 of the structure, it being possible for one glass sheet to present one form of assembly while the other glass sheet presents another form of assembly.

1-24. (canceled)

25. A flat lamp comprising:
at least two glass substrates kept mutually parallel and defined in an internal gas-filled space;
two electrodes associated with the glass substrates and away from the internal space, in which an internal face of at least one substrate turned toward the internal space is coated with a phosphor material,
wherein at least one of the electrodes is covered with at least one electrical insulation that may be formed by at least one of the glass substrates or be associated with at least one of the glass substrates.

26. The lamp as claimed in claim 25, wherein at least one electrode is affixed to the surface of the external face of the substrate with which it is associated and is covered with at least one electrical insulation, the electrode being incorporated into the surface of the glass substrate or of the electrical insulation.

27. The lamp as claimed in claim 25, wherein at least one electrode is incorporated into the electrical insulation, either within its very thickness or on a surface.

28. The lamp as claimed in claim 26, wherein the electrical insulation is made of glass or of a transparent plastic of one of: polyvinyl butyral (PVB), ethylene/vinyl acetate (EVA), or polyethylene terephthalate (PET).

29. The flat lamp as claimed in claim 25, wherein the electrical insulation associated with the electrode is assembled with one or more other additional electrical insulations.

30. The lamp as claimed in claim 26, wherein at least one additional electrical insulation is formed by another glass substrate that is laminated to at least one glass substrate by an intermediate film that can make the two substrates adhere to each other.

31. The lamp as claimed in claim 25, wherein the electrical insulation constitutes a sheet exhibiting an optical effect.

32. The lamp as claimed in claim 25, wherein the electrodes are continuous, conducting and transparent coatings, each located on an external face side of a substrate and covering at least part of facing surfaces of the substrates.

33. The lamp as claimed in claim 32, wherein the electrodes cover all of the external faces of the glass substrates.

34. The lamp as claimed in claim 32, wherein the continuous coatings are in a form of an array of parallel band, having a bandwidth of between 3 and 15 mm, and a non-conducting space between two adjacent bands, having a width greater than the width of the bands, the coatings deposited on the two substrates being offset by 180° to prevent two opposed conducting bands of the two substrates from facing each other.

35. The lamp as claimed in claim 25, wherein the electrodes are formed from a metal oxide having electronic vacancies.

36. The flat lamp as claimed in claim 25, wherein at least one of the two electrodes is an integrated metal grid, where appropriate inserted in between two plastic sheets, or the electrode is in a form of a layer deposited on and incorporated into a plastic film.

37. The lamp as claimed in claim 25, wherein at least part of the internal face of at least one of the two substrates is coated with a phosphor material.

38. The lamp as claimed in claim 37, wherein the phosphor is selected to determine a color of illumination.

39. The lamp as claimed in claim 25, wherein spacers, made of a non-conducting material, are placed between the two glass substrates, the spacers maintaining separation between the two substrates.

40. The lamp as claimed in claim 39, wherein the separation between the two substrates is around 0.3 to 5 mm.

41. The lamp as claimed in claim 39, wherein the spacers are made of glass.

42. The lamp as claimed in claim 39, wherein a lateral surface of the spacers is coated with a phosphor material.

43. The lamp as claimed in claim 25, wherein gas pressure in the internal space is around 0.05 to 1 bar.

44. The lamp as claimed in claim 25, wherein one of the glass substrates has at least one hole drilled through its thickness that is obstructed by a seal.

45. The lamp as claimed in claim 25, wherein a contour of the glass substrates is polygonal, concave or convex, or curved with a constant or variable radius of curvature.

46. The lamp as claimed in claim 25, having two illuminating faces.

47. A process for manufacturing a lamp as claimed in claim 25, comprising:
optionally, depositing at least one electrode on one of the glass substrates;
screen-printing phosphor on at least one of the glass substrates, one of which is provided with a hole drilled through its thickness and on an opposite side from the electrode if the electrode is deposited on the same substrate;
depositing spacers on one of the glass substrates;
joining the glass substrates together to be parallel;
sealing an internal space by a peripheral sealing material;
replacing atmosphere contained in the internal space, by the hole, with plasma gas; and
obstructing the hole by a seal;
optionally, joining at least one first electrical insulation to at least one glass substrate, the electrical insulation configured to cover or to incorporate, internally or on a surface, the electrode with which one of the faces of the substrate to be associated, or configured to cover the electrode that is associated with a second electrical insulation that is joined to the first electrical insulation.

48. Application of a lamp as claimed in claim 25 to production of architectural or decorative elements that illuminate and/or have a display function.
